(19) United States
(12) Patent Application Publication
(10) Pub. No.: US 2024/0303387 A1
(43) Pub. Date: Sep. 12, 2024

(54) SIMULATING PHYSICAL STABILITY PARAMETERS OF ENCLOSED SURROUNDING FOR SECURITY CONTROL

(71) Applicant: International Business Machines Corporation, Armonk, NY (US)

(72) Inventors: Fang LU, Billerica, MA (US); Tasha STEWART, Decatur, GA (US); Jeremy R. FOX, Georgetown, TX (US); Sarbajit K. RAKSHIT, Kolkata (IN)

(21) Appl. No.: 18/178,848

(22) Filed: Mar. 6, 2023

(51) Int. Cl. G06F 30/17; G06F 30/20

(52) U.S. Cl. CPC G06F 30/17; G06F 30/20; G06F 2119/02

(57) ABSTRACT

Embodiments of the disclosure provide systems and methods for implementing enhanced access control of an enclosed surrounding. Access control to an enclosed surrounding is implemented using digital twin simulation, real-time monitoring and identifying physical stability parameters of the enclosed surrounding. The system evaluates multiple physical stability parameters of an enclosed surrounding, based on a digital twin simulation, to identify a degree of stability or safety inside the enclosed surrounding. The system identifies types of protection needed, and assigns an appropriate security rule for entering the enclosed surrounding. The system can receive a user input of testing parameters for a proposed action within the enclosed surrounding and evaluate the received testing parameters, based on the digital twin simulation, to trigger alerts and provide a plan for the user to safely perform the proposed action.

### BACKGROUND

The present invention relates to intelligent security control systems, and more specifically, to systems and methods for implementing enhanced access control of an enclosed surrounding utilizing digital simulation, real-time monitoring and identifying physical stability parameters of the enclosed surrounding.

A virtual model or a Digital Twin model of a building or physical structure can reconstruct relevant metrics from the physical structure in a virtual digital twin simulation. Digital twin technology can enable various facility management functions, such as controlling heating, cooling, and lighting.

Multiple physical stability parameters of an enclosed surrounding can result in various problems and possible accidents. Unstable and dangerous conditions in a given enclosed surrounding for example can result when packages are not stacked properly on a warehouse shelf, various hazardous elements are located in open spaces, or any physical structure is not stable. As a result, accidents, damage to objects and property, and harm to humans can occur in the enclosed surrounding. At the highest level, when an element in the enclosed surrounding is not stable, movements in the enclosed surrounding might cause accidents, and incidences of human mishandling of objects and careless movements can further amplify the prospects of accidents.

### SUMMARY

Embodiments of the present disclosure provide a system and methods for implementing enhanced access control of an enclosed surrounding. The disclosed system and methods enable enhanced access control using digital simulation, real-time monitoring and identifying physical stability parameters of the enclosed surrounding.

In a non-limiting disclosed method comprises determining, based on a digital twin simulation of an enclosed surrounding, a degree of physical stability inside the enclosed surrounding; determining, based on the degree of physical stability, suitability of the enclosed surrounding for a worker to perform activity; and based on the determined suitability, assigning an appropriate security rule for entering the enclosed surrounding.

Other disclosed embodiments include a computer system and computer program product for implementing enhanced access control of an enclosed surrounding, implementing features of the above-disclosed methods.

### BRIEF DESCRIPTION OF THE DRAWINGS

FIG. 1 is a block diagram of an example computer environment for use in conjunction with one or more disclosed embodiments for implementing enhanced access control of an enclosed surrounding;

FIG. 2 is a block diagram of an example system for implementing enhanced access control of an enclosed surrounding of one or more disclosed embodiments;

FIG. 3 is a flow chart of example operations of the system of FIG. 2 for implementing enhanced access control of an enclosed surrounding of one or more disclosed embodiments;

FIG. 4 is a flow chart of example operations of a method for implementing enhanced access control of an enclosed surrounding of one or more disclosed embodiments; and

FIG. 5 is a flow chart of an example method for implementing enhanced access control of an enclosed surrounding of one or more disclosed embodiments.

### DETAILED DESCRIPTION

Embodiments of the disclosure provide systems and methods for implementing enhanced access control of an enclosed surrounding. Embodiments of the present disclosure provide effective and efficient techniques for implementing security and access control of an enclosed surrounding. Embodiments of the disclosure can provide access control to the enclosed surrounding using digital twin simulation, real-time monitoring, and identifying physical stability parameters of the enclosed surrounding. For example, a disclosed system can evaluate multiple stability parameters of an enclosed surrounding based on a digital simulation, identify what types of protection is needed, and assign an appropriate security rule for entering the enclosed surrounding. The system can evaluate multiple stability parameters, to identify a degree of stability of the stability parameters, such as indicating hazardous placement of objects, hazardous materials, high or low temperatures in the enclosed surrounding possibly causing instability of objects, and the like. The system can predict the type of activity the human worker or robotic worker can safely perform in the enclosed surrounding based on an identified degree of instability of the multiple stability parameters and determine access permissions and access limitations for workers and robotic machines.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

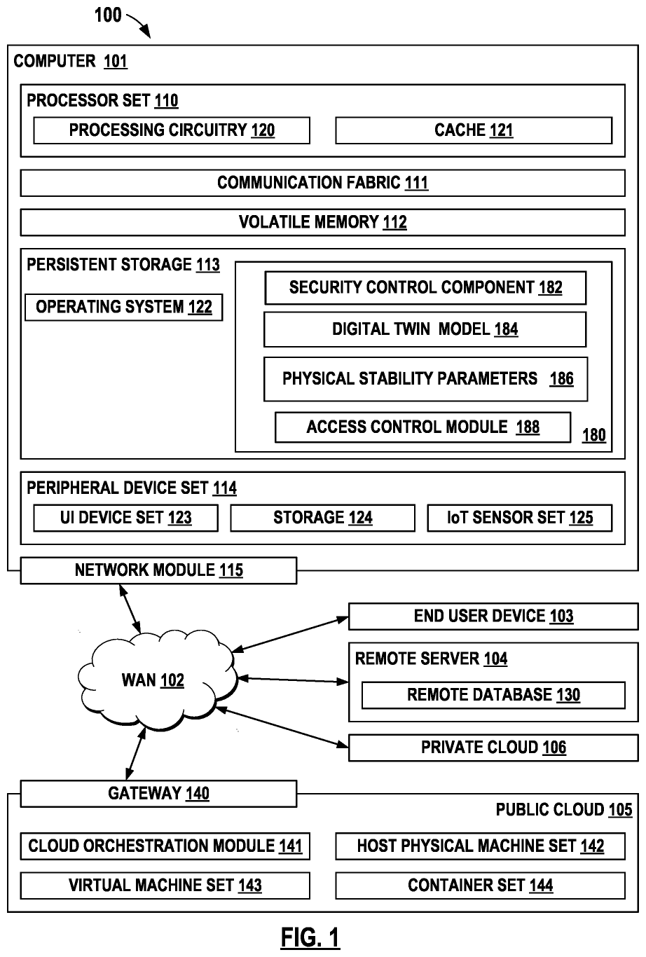

Referring to FIG. 1, a computing environment 100 contains an example of an environment for the execution of at least some of the computer code involved in performing the inventive methods, such as a Security Control Component 182, a Digital Twin Model 184, Physical Stability Parameters 186, and an Access Control Module 188 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the disclosure provide systems and methods for implementing enhanced security control of an enclosed surrounding, for example using digital twin simulation, real-time monitoring and evaluating physical stability parameters of the enclosed surrounding. Disclosed systems and methods can provide access control to the enclosed surrounding, for example, evaluating multiple stability parameters of the enclosed surrounding based on a digital simulation to identify any limitations and permissions to control access to the enclosed surrounding. A security controller can identify types of protection is needed, and assign an appropriate security rule for entering the enclosed surrounding. For example, the security controller can identify types of activity that human or robotic workers can perform in the enclosed surrounding to determine access permissions and access limitations for workers and robotic machines. The security controller can identify types of activity that should be restricted for workers and robotic machines in the enclosed surrounding and further identify real-time types of useful protection actions to enable safety and stability of the enclosed surrounding.

In a disclosed embodiment, the system can update an access control policy responsive to identified types of activity that should be restricted and security protection actions needed in the enclosed surrounding for secure access. The disclosed system can use the access control system to validate proper access limitations for workers, for example, from unique worker identification and skill level of a given worker. The disclosed system can implement access control to the enclosed surrounding based on identified limitations and permissions for a given worker and for multiple human and robotic workers.

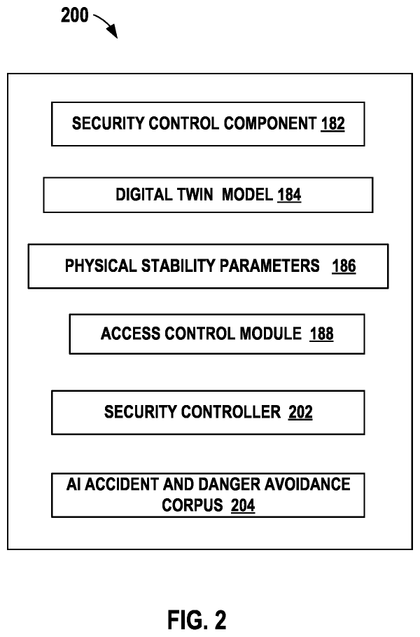

FIG. 2 illustrates an example system 200 for implementing enhanced a control of an enclosed surrounding, for example using digital twin simulation, real-time monitoring and identifying physical stability parameters of the enclosed surrounding of one or more disclosed embodiments. System 200 can be used in conjunction with the computer 101 and cloud environment of the computing environment 100 of FIG. 1 for implementing access control of an enclosed surrounding of disclosed embodiments.

System 200 includes the Control Component 182, the Digital Twin Model 184, the Physical Stability Parameters 186, and the Access Control Module 188, for example used together with processor computer 101 of the computing environment 100 of FIG. 1 for implementing enhanced access control of an enclosed surrounding of disclosed embodiments. System 200 includes a Security Controller 202 and an Artificial Intelligence (AI) Accident and Danger Avoidance Corpus 204 for implementing enhanced access control operations of disclosed embodiments.

System 200 can build the Digital Twin model 184 of the physical enclosed surrounding to identify the safety and stability of the enclosed surrounding for implementing access control of one or more disclosed embodiments.

In a disclosed embodiment, system 200 can use multiple sensors for monitoring and scanning modules to scan the enclosed surrounding to determine a degree of stability or safety of the Physical Stability Parameters 186 based on a digital twin simulation for the Digital Twin model 184. For example, the system can use various Internet of Things (IoT) sensors enabled to capture real-time information from the enclosed surrounding for the Physical Stability Parameters 186. For example, system 200 can use sensors to detect movement, thermal conditions, liquid, gas, and chemicals of the Physical Stability Parameters 186 within the enclosed surrounding. System 200 can scan the enclosed surrounding in real-time to capture images of objects, the physical position of different objects and identify how specific objects are placed. System 200 can evaluate the captured images and captured real-time sensor information for the Physical Stability Parameters 186 based on the digital twin simulation to identify what types of accidents can happen, and how to avoid accidents.

System 200 can evaluate the captured images, for example using Optical Character Recognition (OCR) and digital twin and machine translation technology to analyze text in different languages to gather information about different objects, such as the content, dimensions, and weight of a given object or group of objects. System 200 can consider local culture and language when rendering images and instructions in a Digital Twin simulation to provide sufficient visual indicators of important information. For example, the system further can keep necessary objects separated by a reasonable distance based upon evaluating potential chemical reactions that could be triggered among different object substances, for example resulting from high temperature within the enclosed surrounding.

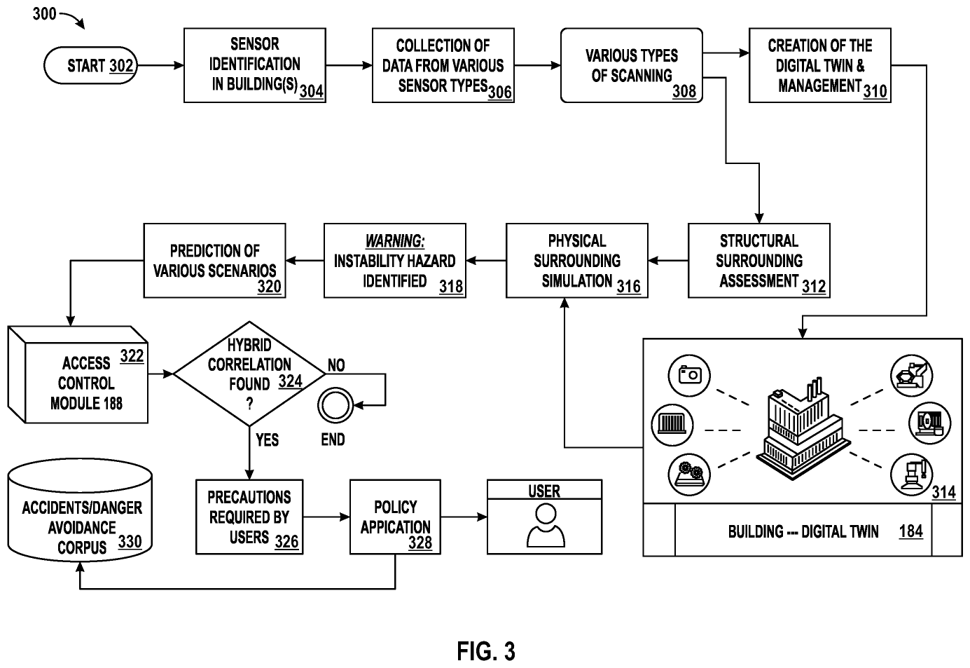

Referring to FIG. 3, illustrated example system operations 300 of system 200 for implementing enhanced access control of an enclosed surrounding of one or more disclosed embodiments starting at block 302. As indicated at block 304, initial system operations include sensor identification, setup, and configuration for collecting predefined types of sensor information for Physical Stability Parameters 186 in the enclosed surrounding. Sensors in system 200 can include multiple IoT enabled sensors to capture real-time information for multiple Physical Stability Parameters 186 for the system. System 200 can include multiple sensors, such as at least one movement sensor, thermal sensor, liquid detection sensor, gas detection sensor, and the like to capture real-time information to be evaluated to identify instability and hazardous conditions. The sensor information can enable system 200 to identify real-time types of protection actions that can be implemented to enable safety and stability of the enclosed surrounding and identify various types of activity that should be restricted in the enclosed surrounding.

As indicated at block 306, system operations include collection of data from available sensors, for example performed by the security controller 202 to collect data for predefined Physical Stability Parameters 186, using the Security Control Component 182. At block 308, system 200 can use various types of scanning to capture images within the enclosed surroundings, where the captured images are evaluated for example to identify hazardous and unstable conditions. At block 310, system 200 uses the collected information and other available data for the enclosed surrounding to create the Digital Twin model 184 and to provide specific updates to the security control component 182 for the enclosed surrounding, such as for access and security control management of the enclosed surrounding. At block 312, system 200 performs structural surrounding assessment of the enclosed surrounding based on the collected sensor data at block 306 and the captured scanning and image data at block 308.

At block 314, a schematically illustrated virtual Digital Twin simulation with contents of the enclosed surrounding is rendered using digital twin technology from the Digital Twin model 184 for a given enclosed surrounding, such as a building, a laboratory, or warehouse, which represents the collected information and other available data at block 310. The virtual representation of Digital Twin model 184 is updated from real-time collected data, and used for the virtual Digital Twin simulation with machine learning and reasoning to enable decision-making to implement enhanced security control of the enclosed surrounding.

At block 316, system 200 implements a physical surrounding simulation, identifying how objects are placed the enclosed surrounding, using digital twin technology with input from the Digital Twin simulation with contents at block 314 and the structural surrounding assessment from block 312. At block 318, system 200 can issue a warning or alert for any instability or hazard identified from the virtual physical surrounding simulation. System 200 can identify what types of precautions should to be taken to handle the unstable situation inside the enclosed surrounding.

At block 320, system 200 evaluates various scenarios, based on the digital twin simulation, to identify and predict instability within the enclosed surrounding, and identifying what types of forces can make the enclosed surrounding unstable. At block 320, system 200 can identify, based on the digital twin simulation, what types of accident can happen in the enclosed surrounding. At block 320, system 200 can evaluate the various scenarios using different types of unstable conditions, data of accidents that happened in the past and in the similar industries, such as using data accessed from the AI Accident and Danger Avoidance Corpus 204. System 200 can identify types of factors that can disturb the stability inside the enclosed surrounding, and accordingly notify the Access Control Module 188 for restricting the human workers from performing specific activities, or possibly restricting use of specific accessories inside the enclosed surrounding. For example, system 200 can identify specific accessory types with human or robotic workers (e.g., ladder or fork lift) used to predict what activity can be safely performed in the enclosed surrounding.

At block 322, system 200 can provide the Access Control Module 188 with predicted problems based on an identified degree of physical stability for Physical Stability Parameters 186 of the enclosed surrounding. For example, system 200 can predict problems such as box or boxes in an unstable position on a shelf in the enclosed environment, and a chemical reaction of a stored object possibly resulting from high temperature in the enclosed environment. For example, system 200 can use the Access Control Module 188, for validating types of required precaution for the workers. System 200 can use the Access Control Module 188 for example to authenticate access for any given worker, and identify if the worker requires any specific precaution, such as moving carefully near an unstable box or move specific objects spaced apart to avoid possible chemical reactions, and any activity to be limited or restricted for the worker and for all workers in the enclosed surrounding. At decision block 324, system 200 can check for any hybrid correlation between Access Control Module 188 and the Digital Twin simulation, identifying types of accidents that can happen, and how such accidents can be avoided. At block 326, system 200 provides precautions that the users should take for an identified possible accident that can happen, and how to avoid the accident. For example precautions can include specific worker activities that should be performed or that should be avoided, such as restricting use of specific products, such as cleaning products in a designated area. At block 328, system 200 uses the Access Control Module 188 for gathering information for triggering action by system 200 to apply any change in the Access Control Policy, for example based on a change in a contextual situation and stability of the enclosed surrounding. System 200 can update an application of the access control policy for a user and at block 330 update the Accident and Danger Avoidance Corpus 204.

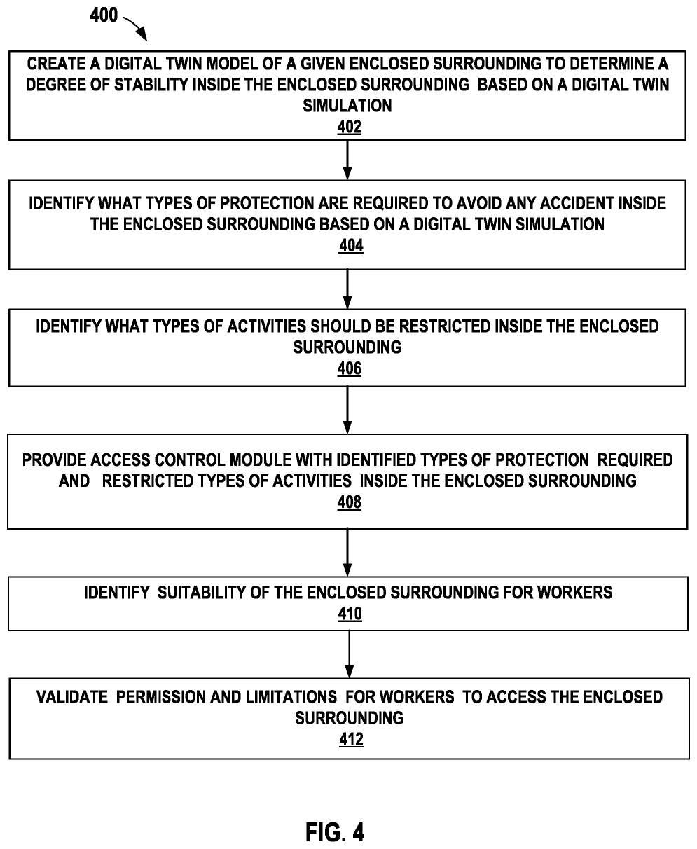

FIG. 4 illustrates an example method 400 for implementing enhanced security control of an enclosed surrounding of one or more disclosed embodiments. At block 402, system 200 creates a Digital Twin simulation of a given enclosed surrounding, to determine a degree of stability (e.g., safety) inside the enclosed surrounding. At block 404, system 200 can identify what types of protection are required to avoid any accident inside the enclosed surrounding. For example, system 200 can identify changes needed to make the enclosed surrounding stable, such as moving or repositioning an unstable box from a warehouse shelf or moving objects and removing an identified object having leaking liquid. At block 406, system 200 can identify what types of activities should be restricted inside the enclosed surrounding, such as using a forklift in a designated area, or locating specific objects close together.

At block 408, system 200 provide the Access Control Module 188 with identified types of protection required and restricted types of activities inside the enclosed surrounding. For example, system 200 can identify any types of protective gear that worker should wear to enter the enclosed surrounding. System 200 can notify the Access Control Module 188 to limit access to the enclosed surrounding to specific workers. At block 410, system 200 can identify the suitability of the enclosed surround for workers based on the digital twin simulation. For example, system 200 can determine a degree of stability or safety of the Physical Stability Parameters 186 based on a digital twin simulation 186. At block 412, system 200 can validate permission and limitations for a worker or group of workers to access the enclosed surrounding. For example, system 200 can limit and deny access to the enclosed surrounding based on the identified suitability or degree of stability of the enclosed surrounding.

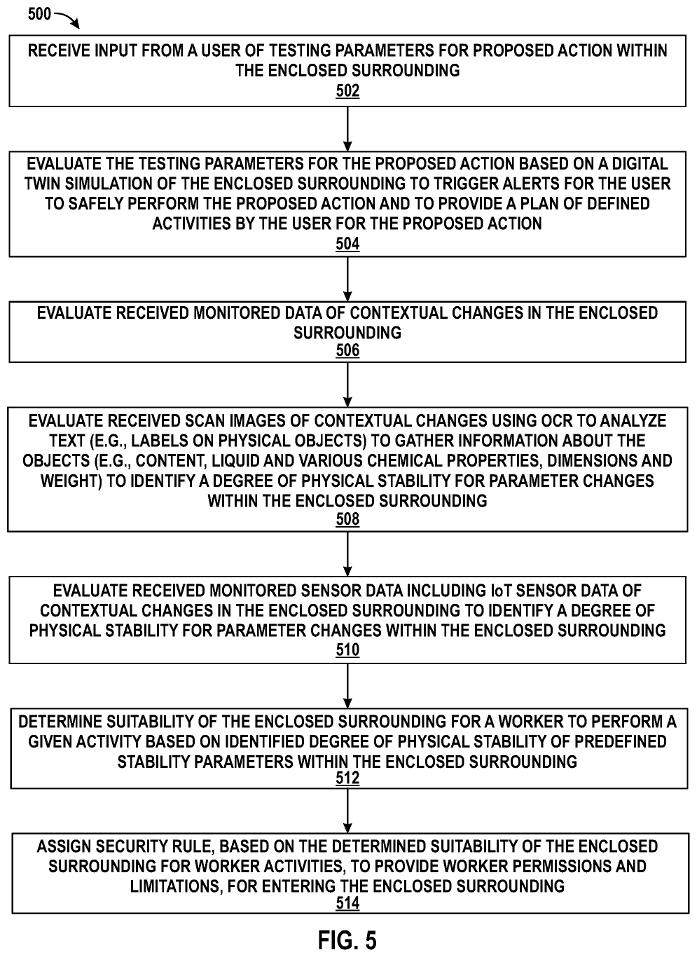

FIG. 5 is a flow chart of an example method 500 for implementing enhanced security control of an enclosed surrounding of one or more disclosed embodiments. As indicated at block 502, system 200 can receive testing parameters for a proposed action within the enclosed surrounding. For example, a user can input testing parameters for loading large objects on a warehouse shelf, or for various specific activities within the enclosed surrounding. At block 504, system 200 evaluates the received testing parameters from the user based on the digital twin simulation for the enclosed surrounding to trigger alerts for the user to safely perform the proposed action, e.g., identify how to load and position objects on a warehouse shelf to avoid stability problems. System 200 evaluates the received testing parameters, based on the digital twin simulation for the enclosed surrounding, to provide a plan of defined activities by the user to safely perform proposed action.

At block 506, system 200 evaluates received monitored data for contextual changes in the enclosed surrounding based on the digital twin simulation of the enclosed surrounding to identify a degree of physical stability within the enclosed surrounding. At block 508, system 200 evaluates captured scan images of objects for the contextual changes to identify a degree of physical stability within the enclosed surrounding. For example, system 200 evaluates captured scan images for the contextual changes using OCR and machine translation technology to analyze text carried by the objects and gather information about different objects, such as the content, dimensions, and weight of a given object or group of objects (e.g., objects on a pallet). System 200 uses such gathered information from the captured scan images to identify a degree of physical stability within the enclosed surrounding.

At block 510, system 200 evaluates, based on the digital twin simulation, received real-time monitored data including received sensor and IoT sensor data indicating contextual changes in the enclosed surrounding, to identify a degree of physical stability within the enclosed surrounding. The received real-time monitored data can include for example, a high temperature or a hazardous chemical within the enclosed surrounding that is evaluated by system 200 based on the digital twin simulation to identify suitability of the enclosed surrounding for access by workers. At block 512, system 200 determines, based on the degree of physical stability identified at block 508 and 510, the suitability of the enclosed surrounding for a worker to perform a given activity.

At block 514, system 200 assigns a security rule, based on the determined suitability of the enclosed surrounding for worker activity, to provide worker permissions and limitations, for entering the enclosed surrounding. System 200 can identify types of precautions to be taken to handle various unstable situations inside the enclosed surrounding, and assign an appropriate security rule to enter the enclosed surrounding. System 200 can assign the appropriate security rule, for example to validate specific users to be allowed to enter the enclosed surrounding. For example, the assigned security rule can identify specific workers or all workers to limit entry or deny entry to the enclosed environment. The assigned security rule can identify activities or actions needed to correct an instability or to limit specific activities or actions within the enclosed surrounding,

While the foregoing is directed to embodiments of the present invention, other and further embodiments of the invention may be devised without departing from the basic scope thereof, and the scope thereof is determined by the claims that follow.

What is claimed is:

1. A method comprising:
providing a digital twin simulation of an enclosed surrounding to implement access control;
determining a degree of physical stability inside the enclosed surrounding, based on the digital twin simulation of the enclosed surrounding;
determining suitability of the enclosed surrounding for worker activity inside the enclosed surrounding, based on the determined degree of physical stability; and
assigning an appropriate security rule for entering the enclosed surrounding based on the suitability of the enclosed surrounding for worker activity.

2. The method of claim 1, wherein providing the digital twin simulation of the enclosed surrounding further comprises capturing information from sensors in the enclosed surrounding including Internet of Things (IoT) sensors to detect predefined physical stability parameters of the enclosed surrounding.

3. The method of claim 1, wherein providing the digital twin simulation of the enclosed surrounding further comprises detecting predefined physical stability parameters of the enclosed surrounding, wherein the predefined physical stability parameters comprise one or more of temperature conditions, liquid, gas, chemicals, and movement of objects within the enclosed surrounding.

4. The method of claim 1, wherein providing the digital twin simulation of the enclosed surrounding further comprises scanning the enclosed surrounding to capture images of objects inside the enclosed surrounding.

5. The method of claim 1, wherein providing the digital twin simulation of the enclosed surrounding further comprises using image recognition and digital twin technology to identify objects within the enclosed surrounding.

6. The method of claim 1, wherein providing the digital twin simulation of the enclosed surrounding further comprises using Optical Character Recognition (OCR) to analyze text in captured images of objects inside the enclosed surrounding.

7. The method of claim 1, wherein providing the digital twin simulation of the enclosed surrounding further comprises using Optical Character Recognition (OCR) to identify features of a given object, wherein the object features comprise one or more of position, content, dimensions and weight of the object.

8. The method of claim 1, further comprises receiving user input of testing parameters for a proposed action within the enclosed surrounding; and evaluating the received testing parameters, based on the digital twin simulation, to trigger alerts for the user to safely perform the proposed action.

9. The method of claim 1, further comprises receiving user input of testing parameters for a proposed action within the enclosed surrounding and identifying a plan of defined activities by the user, based on the digital twin simulation, for the proposed action.

10. The method of claim 1, wherein assigning appropriate security rule for entering the enclosed surrounding further comprises validating specific users allowed to enter the enclosed surrounding.

11. A system, comprising:
a processor; and
a memory, wherein the memory includes a computer program product configured to perform operations for implementing access control of an enclosed surrounding, the operations comprising:
providing a digital twin simulation of the enclosed surrounding to implement access control;
determining a degree of physical stability inside the enclosed surrounding, based on the digital twin simulation of the enclosed surrounding;
determining suitability of the enclosed surrounding for worker activity inside the enclosed surrounding, based on the determined degree of physical stability; and
assigning an appropriate security rule for entering the enclosed surrounding based on the suitability of the enclosed surrounding for worker activity.

12. The system of claim 11, wherein providing the digital twin simulation of the enclosed surrounding further comprises capturing information from sensors in the enclosed surrounding including Internet of Things (IoT) sensors to detect predefined physical stability parameters of the enclosed surrounding.

13. The system of claim 11, wherein providing the digital twin simulation of the enclosed surrounding further comprises scanning the enclosed surrounding to capture images of objects inside the enclosed surrounding.

14. The system of claim 11, further comprises receiving user input of testing parameters for a proposed action within the enclosed surrounding and evaluating the received testing parameters, based on the digital twin simulation, to trigger alerts for the user to safely perform the proposed action.

15. The system of claim 11, further comprises receiving user input of testing parameters for a proposed action within the enclosed surrounding and identifying a plan of defined activities by the user, based on the digital twin simulation, for the proposed action.

16. A computer program product for implementing enhanced access control of an enclosed surrounding, the computer program product comprising:
a computer-readable storage medium having computer-readable program code embodied therewith, the computer-readable program code executable by one or more computer processors to perform an operation comprising:
providing a digital twin simulation of the enclosed surrounding to implement access control;
determining a degree of physical stability inside the enclosed surrounding, based on the digital twin simulation of the enclosed surrounding;
determining suitability of the enclosed surrounding for worker activity inside the enclosed surrounding, based on the determined degree of physical stability; and
assigning an appropriate security rule for entering the enclosed surrounding based on the suitability of the enclosed surrounding for worker activity.

17. The computer program product of claim 11, wherein providing the digital twin simulation of the enclosed surrounding further comprises capturing information from sensors in the enclosed surrounding including Internet of Things (IoT) sensors to detect predefined physical stability parameters of the enclosed surrounding.

18. The computer program product of claim 16, wherein providing the digital twin simulation of the enclosed surrounding further comprises scanning the enclosed surrounding to capture images of objects inside the enclosed surrounding.

19. The computer program product of claim 16, further comprises receiving user input of testing parameters for a proposed action within the enclosed surrounding and evaluating the received testing parameters, based on the digital twin simulation, to trigger alerts for the user to safely perform the proposed action.

20. The computer program product of claim 16, further comprises receiving user input of testing parameters for a proposed action within the enclosed surrounding and identifying a plan of defined activities by the user, based on the digital twin simulation, for the proposed action.
